(19) United States
(12) Patent Application Publication
(10) Pub. No.: US 2012/0228912 A1
(43) Pub. Date: Sep. 13, 2012

(54) VEHICLE SEAT

(75) Inventors: Ludger Alofs, Krefeld (DE); Markus Stepke, Moers (DE)

(73) Assignee: SIEMENS AKTIENGESELLSCHAFT, MUENCHEN (DE)

(21) Appl. No.: 13/504,565

(22) PCT Filed: Oct. 22, 2010
(86) PCT No.: PCT/EP10/65989

§ 371 Date: Apr. 27, 2012

(30) Foreign Application Priority Data
Oct. 27, 2009 (DE) 10 2009 050 903.8

(51) Int. Cl. B60N 2/20; B60N 2/22

(52) U.S. Cl. 297/342

(57) ABSTRACT

A vehicle seat, which can be moved between a sitting position and a reclining position, has a seat cushion, a back cushion, and a head cushion. The seat cushion moves horizontally between the sitting position and the reclining position, and the relative angle between the seat cushion and the back cushion is increased, wherein the contour of the back cushion can be changed and a lower edge of the back cushion follows a movement of the seat cushion, whereas an upper edge of the back cushion is decoupled from a horizontal movement of the seat cushion.

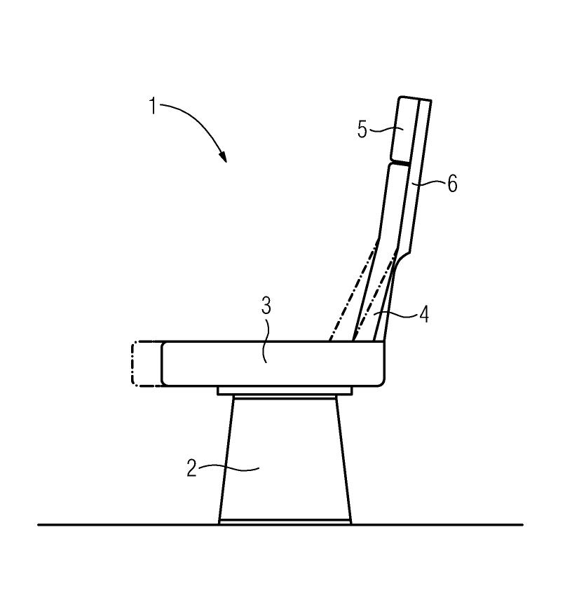

The invention relates to a vehicle seat which may be adjusted between a sitting position and a reclining position, and comprises a seat cushion, a backrest cushion and a head cushion, wherein the seat cushion is able to be moved horizontally between the sitting position and the reclining position for altering the relative angle between the seat cushion and the backrest cushion.

In such a vehicle seat, the seat cushion is adjusted horizontally from the sitting position into the reclining position such that the rigid unit consisting of the head cushion and the backrest cushion is tilted as a whole. As a result, the known vehicle seat requires considerable constructional space for the reclining position.

The required constructional space for an individual vehicle seat also determines the overall seating capacity for a railed vehicle, for example, but also all other public transport vehicles.

Proceeding therefrom, the object of the invention is to develop further the passenger seat mentioned in the introduction such that it requires less constructional space in the reclining position.

This object is achieved in the above-mentioned passenger seat by the backrest cushion being able to be altered in its contour and a lower region of the backrest cushion following a movement of the seat cushion, whilst an upper region of the backrest cushion is decoupled from a horizontal movement of the seat cushion.

This method has the advantage that the relative spacing of the head cushion between two passenger seats arranged in rows remains constant in both sitting positions, so that the vehicle seat as a whole requires less constructional space. As a result, more seats may be provided for an existing vehicle size, wherein comparable seating comfort for a passenger may be achieved. The seating comfort in the reclining position is thus due to the deformability of the backrest cushion, which in this position extends obliquely between the rear edge of the seat cushion and the lower edge of the head cushion, and thus for instance supports the lumbar region of a passenger occupying the vehicle seat.

The backrest cushion may be mounted such that, in the transition between the seating position and reclining position, the relative distance between the lower edge of the backrest cushion and the rear edge of the seat cushion is altered. Thus, it is taken into account that in the sitting position the backrest cushion extends between the head cushion and the seat cushion over a shorter distance than in the reclining position.

Alternatively, it is also possible for the backrest cushion to be mounted such that in the reclining position a gap is produced between the lower edge of the head cushion and the upper edge of the backrest cushion. A further possibility exists in designing the backrest cushion to be extendable so that no gaps are produced between the backrest cushion and the adjacent cushions, namely the seat cushion and the head cushion.

The head cushion is preferably attached in a fixed manner. In this case, there is no difference in the constructional space for the vehicle seat in the reclining position and the sitting position in the region of the head cushion. Alternatively, the head cushion may be horizontally movable to a limited extent, optionally in order to improve the seating comfort further.

In the fixed variant of the fastening of the head cushion, it is advantageous if said head cushion is fastened to a fixed backrest structure of the vehicle seat.

An exemplary embodiment of the invention is described in more detail hereinafter with reference to the drawings. The only FIGURE shows a schematic side view of a vehicle seat.

A vehicle seat 1 is able to be connected in the conventional manner to a vehicle floor via a substructure 2. The vehicle seat 1 comprises a seat cushion 3 which may be adjusted horizontally between a reclining position and a sitting position.

A rear edge of the seat cushion 3 is connected to a lower edge of a backrest cushion 4 such that the lower edge of the backrest cushion 4 follows a horizontal movement of the seat cushion 3 between the reclining position and the sitting position.

In contrast, an upper edge of the backrest cushion 4 is decoupled in its movement from the movement of the seat cushion 3. As the backrest cushion 4 is configured in its contour to be deformable, the vehicle seat 1 is adjusted from the sitting position into the reclining position such that the backrest cushion 4 alters its contour, resulting in an alteration of the bearing surface for the lumbar region of a passenger. A head cushion 5 of the vehicle seat 1, which in the exemplary embodiment shown also extends downward to a shoulder region of a passenger, is fixedly attached and namely to a backrest structure 6 which in turn is rigidly connected in a suitable manner to the substructure 2 of the vehicle seat 1. The upper region of the backrest cushion 4 is also fastened to the backrest structure 6 so that it remains fixed with a horizontal movement of the seat cushion 3.

In the sitting position of the vehicle seat 1 (the sitting position is shown in the FIGURE by a solid line, the reclining position is shown by dashed-dotted lines), the backrest cushion 4 has a reduced thickness in the knee region. As a result, with comparable seat dividers of conventional seats, a passenger located behind the passenger seat 1 has increased freedom of movement in his/her knee region.

The alteration of the contour of the backrest cushion 4 between the sitting position and the reclining position of the vehicle seat 1 results in a variable distance between the lower edge of the head cushion 5 and the rear edge of the seat cushion 3. It is possible to allow for the fact that a gap is permitted either between the lower edge of the head cushion 5 and the upper edge of the backrest cushion 4 or the lower edge of the backrest cushion 4 and the rear edge of the seat cushion 3 when the reclining position is adopted. Alternatively, the backrest cushion 4 may also be designed to be extendable or to overlap.

1-6. (canceled)

7. A vehicle seat configured for adjustment between a sitting position and a reclining position, the vehicle seat comprising:
a seat cushion, a backrest cushion, and a head cushion;
said seat cushion being movable horizontally between the sitting position and the reclining position for altering a relative angle between said seat cushion and said backrest cushion;
said backrest cushion having a lower region, an upper region, and an alterable contour, wherein said lower region of said backrest cushion is dispose to follow a movement of said seat cushion, while said upper region of said backrest cushion is decoupled from the horizontal movement of said seat cushion.

8. The vehicle seat according to claim 7, wherein said backrest cushion is mounted such that, during a transition between the seating position and the reclining position, a relative distance between a lower edge of said backrest cushion and a rear edge of said seat cushion is altered.

9. The vehicle seat according to claim 7, wherein said backrest cushion is mounted such a gap is formed, in the reclining position, between a lower edge of said head cushion and an upper edge of said backrest cushion.

10. The vehicle seat according to claim 7, wherein said backrest cushion is an extendable cushion.

11. The vehicle seat according to claim 7, wherein said head cushion is mounted stationary.

12. The vehicle seat according to claim 11, which further comprises a fixed backrest structure, and wherein said head cushion is fastened to said fixed backrest structure of the vehicle seat.
